(19) United States
(12) Patent Application Publication
(10) Pub. No.: US 2012/0214341 A1
(43) Pub. Date: Aug. 23, 2012

(54) Dual Sealing Structure of RF Coaxial Connector and Related RF Coaxial Connector

(75) Inventors: Mulan Huang, Suzhou (CN); Yujun Zhang, Suzhou (CN); Hongjuan An, Suzhou (CN); Jien Zheng, Suzhou (CN)

(73) Assignee: ANDREW LLC, Hickory, NC (US)

(21) Appl. No.: 13/369,531

(22) Filed: Feb. 9, 2012

(30) Foreign Application Priority Data
Feb. 22, 2011 (CN) 201110042967.2

(51) Int. Cl. H01R 9/05

(52) U.S. Cl. 439/583

(57) ABSTRACT

A dual sealing structure of an RF coaxial connector, with a cable clamping component, a clamping nut, a first sealing ring and a second sealing ring, the cable clamping component having a first end arranged movably in the clamping nut, the first sealing ring positioned inside the surface of the inner side of the clamping nut and located between the end face of the first end and the inner wall of the clamping nut, the second sealing ring arranged on the surface of the outer side of the clamping nut. The first end is restricted by the clamping nut in a direction away from the clamping nut and may be connected with the clamping nut in press-fit or thread connection. A related RF coaxial connector is also provided. The invention has a good sealing effect, fewer components and is cost efficient to manufacture and install.

### FIELD OF TECHNOLOGY

The present invention relates to the field of RF coaxial connector, especially to the field of the sealing structure of RF coaxial connector, in particular to a dual sealing structure of RF coaxial connector and a related RF coaxial connector.

### DESCRIPTION OF RELATED ARTS

RF coaxial connector (also known as RF connector) is an element connecting a RF coaxial cable with a device or a different type of cables, as an element for electrical connection or disconnection of transmission lines. It belongs to mechatronics products. In brief, it mainly functions as a bridge.

Please refer to FIG. 1, FIG. 1 shows a RF coaxial connector currently used, including a connector main body 1, a cable clamping component 2, a V-ring 3, a flat gasket 4 and a clamping nut 5, when it is used, the outer shielding layer of one end of a RF coaxial cable is removed, to expose the outer conductor, the RF coaxial cable is sheathed by the clamping nut 5, the flat gasket 4 and the V-ring 3 in sequence, the notch of the V-ring 3 is oriented in the direction opposite to the flat washer 4, then the outer conductor is sheathed by the cable clamping component 2 which props against the cross-section of the outer shielding layer at the same time, the end face of the cable clamping component 2 facing the notch of the V-ring 3 has a configuration that can be engaged with the notch of the V-ring 3, then the outer conductor is folded upwards and the inner shielding layer exposed is removed, so as to expose the center conductor, then this assembly above is inserted into the connector main body 1, the clamping nut 5 is rotated so as to be connected with the connector main body 1 through a thread engagement. During this period, the cable clamping component 2 is snapped into the notch of the V-ring 3, two ends of the flat gasket 4 prop against the clamping nut 5 and the V-ring 3 respectively, so as to seal the cable clamping component 2 and the clamping nut 5, in addition, the outer side of the V-ring 3 can prop against the inner wall of the connector main body 1 to be sealed with the inner wall, so as to prevent water from entering into the connector.

However, the above connector structure has the following problems:

1. The above-described connector structure is a multi-part structure, its process is complex, and its production cost and price are high;

2. For the above-described connector structure is a multi-part structure, the components are easily lost, these components, particularly the V-ring 3 and the flat gasket 4, can be easily missed in the installation outdoors, at the same time the installation time is long;

3. For the above-described connector structure adopts the V-ring 3, while the V-ring 3 will be destroyed after compression (divided into two parts), and can not be installed many times, the use cost is high;

4. For the outer side of the V-ring 3 props against the inner wall of the connector main body 1 to be sealed with the inner wall, the sealing effect is not good due to the insufficient force for propping against the inner wall.

Therefore, there is a need to provide a dual sealing structure of RF coaxial connector, which has not only a good sealing effect, but also fewer components, is simple to manufacture and of low production cost, its components can not be easily lost, its installation time is short, it can be installed repeatedly, and its use cost is low.

### SUMMARY OF THE INVENTION

Aspects of the present invention generally pertain to a dual sealing structure of RF coaxial connector and a related RF coaxial connector, and the dual sealing structure of RF coaxial connector is designed skillfully, has not only a good sealing effect, but also fewer components, is simple to manufacture and of low production cost, its components can not be easily lost, its installation time is short, it can be installed repeatedly, and its use cost is low, therefore the present invention is suitable for large-scale popularization.

In order to realize the above aims, in a first aspect of the present invention, a dual sealing structure of RF coaxial connector is provided, and comprises:

a clamping nut, used to be connected with the connector main body of the RF coaxial connector;

a cable clamping component, comprising a first end which is arranged movably in the clamping nut;

a first sealing ring, positioned inside the surface of the inner side of the clamping nut and located between the end face of the first end and the inner wall of the clamping nut; and

a second sealing ring arranged on the surface of the outer side of the clamping nut and used to be sealed with the connector main body.

In a further aspect, the first end is restricted by the clamping nut in a direction away from the clamping nut.

In a further aspect, the first end and the clamping nut are connected in press-fit or thread connection.

In yet another aspect, a first convex part is arranged on the surface of the outer side of the first end, a second convex part is arranged on the surface of the inner side of the clamping nut, the first convex part is positioned between the second convex part and the first sealing ring and restricted by the second convex part in a direction away from the clamping nut, so that the first end and the clamping nut are connected in press-fit connection.

In yet another aspect, a first thread is arranged on the surface of the outer side of the first end, a second thread is arranged on the surface of the inner side of the clamping nut, the first thread is engaged with the second thread, so that the first end and the clamping nut are connected in thread connection.

In a further aspect, the clamping nut is used to be connected with the connector main body in press-fit or thread connection.

In yet another aspect, a third convex part used to be connected with the connector main body in press-fit connection is arranged on the surface of the outer side of the clamping nut.

In yet another aspect, a third thread used to be connected with the connector main body in thread connection is arranged on the surface of the outer side of the clamping nut.

In a further aspect, the first sealing ring and the second sealing ring are any one of an O-ring, a rectangular ring and a square ring respectively.

In a second aspect of the present invention, a dual sealing structure of RF coaxial connector is provided, and comprises:

a clamping nut, used to be connected with the connector main body of the RF coaxial connector in press-fit or thread connection;

a cable clamping component, comprising a first end which is arranged movably in the clamping nut and restricted by the clamping nut in a direction away from the clamping nut;

a first sealing ring, positioned inside the surface of the inner side of the clamping nut and located between the end face of the first end and the inner wall of the clamping nut; and

a second sealing ring arranged on the surface of the outer side of the clamping nut and used to be sealed with the connector main body.

In a further aspect, the first end and the clamping nut are connected in press-fit or thread connection.

In yet another aspect, a first convex part is arranged on the surface of the outer side of the first end, a second convex part is arranged on the surface of the inner side of the clamping nut, the first convex part is positioned between the second convex part and the first sealing ring and restricted by the second convex part in a direction away from the clamping nut, so that the first end and the clamping nut are connected in press-fit connection.

In yet another aspect, a first thread is arranged on the surface of the outer side of the first end, a second thread is arranged on the surface of the inner side of the clamping nut, the first thread is engaged with the second thread, so that the first end and the clamping nut are connected in thread connection.

In a further aspect, a third convex part used to be connected with the connector main body in press-fit connection is arranged on the surface of the outer side of the clamping nut.

In a further aspect, a third thread used to be connected with the connector main body in thread connection is arranged on the surface of the outer side of the clamping nut.

In a further aspect, the first sealing ring and the second sealing ring are any one of an O-ring, a rectangular ring and a square ring respectively.

In a third aspect of the present invention, a RF coaxial connector is provided, and comprises a connector main body;

a clamping nut, connected with the connector main body;

a cable clamping component, positioned in the connector main body and comprising a first end which is arranged movably in the clamping nut;

a first sealing ring, positioned inside the surface of the inner side of the clamping nut and located between the end face of the first end and the inner wall of the clamping nut; and

a second sealing ring arranged on the surface of the outer side of the clamping nut and sealed with the connector main body.

In a further aspect, the first end is restricted by the clamping nut in a direction away from the clamping nut.

In a further aspect, the first end and the clamping nut are connected in press-fit or thread connection.

In yet another aspect, a first convex part is arranged on the surface of the outer side of the first end, a second convex part is arranged on the surface of the inner side of the clamping nut, the first convex part is positioned between the second convex part and the first sealing ring and restricted by the second convex part in a direction away from the clamping nut, so that the first end and the clamping nut are connected in press-fit connection.

In yet another aspect, a first thread is arranged on the surface of the outer side of the first end, a second thread is arranged on the surface of the inner side of the clamping nut, the first thread is engaged with the second thread, so that the first end and the clamping nut are connected in thread connection.

In a further aspect, the clamping nut is connected with the connector main body in press-fit or thread connection.

In yet another aspect, a third convex part is arranged on the surface of the outer side of the clamping nut, a fourth convex part is arranged on the inner surface of the connector main body, the third convex part is positioned between the fourth convex part and the interior of the connector main body and restricted by the fourth convex part in a direction away from the connector main body, so that the clamping nut and the connector main body are connected in press-fit connection.

In yet another aspect, a third thread is arranged on the surface of the outer side of the clamping nut, a fourth thread is arranged on the inner surface of the connector main body, the third thread is engaged with the fourth thread, so that the clamping nut and the connector main body are connected in thread connection.

The beneficial effects of the present invention are as follows:

1. The dual sealing structure of RF coaxial connector of the present invention comprises a cable clamping component, a clamping nut, a first sealing ring and a second sealing ring, the cable clamping component comprises a first end which is arranged movably in the clamping nut, the first sealing ring is positioned inside the surface of the inner side of the clamping nut and located between the end face of the first end and the inner wall of the clamping nut, the second sealing ring is arranged on the surface of the outer side of the clamping nut, so that the second sealing ring is used to seal the clamping nut and the connector main body, and the first sealing ring is used to seal the clamping nut and the cable, to achieve the dual sealing, therefore the dual sealing structure of RF coaxial connector is designed skillfully, has not only a good sealing effect, but also fewer components, is simple to manufacture and of low production cost, it can be installed repeatedly, and its use cost is low, therefore the present invention is suitable for large-scale popularization.

2. The cable clamping component of the dual sealing structure of RF coaxial connector of the present invention can be restricted in the clamping nut by the clamping nut in a direction away from the clamping nut, so as to form an one-piece component with the clamping nut, thus the components of the dual sealing structure of RF coaxial connector can not be easily lost, the installation time of the dual sealing structure of RF coaxial connector is short, therefore the dual sealing structure of RF coaxial connector is suitable for large-scale popularization.

3. When the cable clamping component of the dual sealing structure of RF coaxial connector of the present invention can rotate longitudinally and is restricted axially in the clamping nut, so as to form one component, i.e. an one-piece structure, with the clamping nut, the dual sealing structure of RF coaxial connector has additional merits: the clamping nut can rotate freely and independently relative to the cable clamping component, and the cable clamping component is used to position the cable and prevent the cable from rotating following the rotation of the clamping nut, therefore the dual sealing structure of RF coaxial connector is suitable for large-scale popularization.

### BRIEF DESCRIPTION OF THE DRAWINGS

FIG. 1 is a schematic partial cutaway view of the front view of a RF coaxial connector of the prior art.

FIG. 2 is a schematic partial cutaway view of the front view of one embodiment of the present invention.

FIG. 3 is a schematic explosive view of the three-dimensional view of the embodiment shown in FIG. 2.

FIG. 4 is a schematic front view of the embodiment shown in FIG. 3.

FIG. 5A and FIG. 5B are a schematic partial cutaway view of the front view of the cable clamping component and the clamping nut of the embodiment shown in FIG. 3 before and after they are connected in press-fit connection respectively.

FIG. 6 is a schematic partial cutaway view of the front view of assembling the embodiment shown in FIG. 2 and the connector main body of the RF coaxial connector.

FIG. 7 is a schematic partial cutaway view of the front view of the connecting piece of the embodiment shown in FIG. 2 and a RF coaxial cable.

FIG. 8 is a schematic three-dimensional view of assembling the connecting piece shown in FIG. 7 and the connector main body of the RF coaxial connector.

FIG. 9 is a schematic partial cutaway view of the front view of the connecting piece shown in FIG. 7 and the connector main body of the RF coaxial connector assembled.

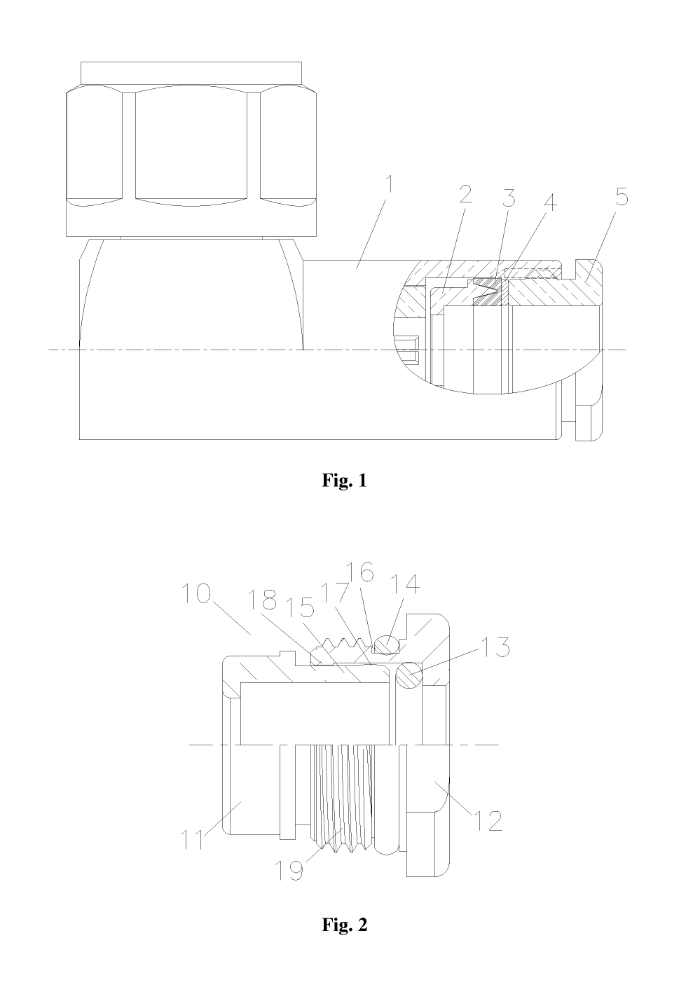

### DETAILED DESCRIPTION OF THE PREFERRED EMBODIMENT

In order to understand the technical content of the present invention clearly, the present invention is further exemplified by reference to the following examples.

Please refer to FIG. 2-4, the dual sealing structure 10 of RF coaxial connector of the present invention comprises a cable clamping component 11, a clamping nut 12 used to be connected with the connector main body 20 of the RF coaxial connector, a first sealing ring 13 and a second sealing ring 14, the cable clamping component 11 comprises a first end 15 which is arranged movably in the clamping nut 12, the first sealing ring 13 is positioned inside the surface of the inner side of the clamping nut 12 and located between the end face of the first end 15 and the inner wall of the clamping nut 12, the second sealing ring 14 is arranged on the surface of the outer side of the clamping nut 12 and used to be sealed with the connector main body 20.

Preferably, as shown in FIG. 2-5B, a groove 16 can be provided on the surface of the outer side of the clamping nut 12, and the second sealing ring 14 is positioned in the groove 16.

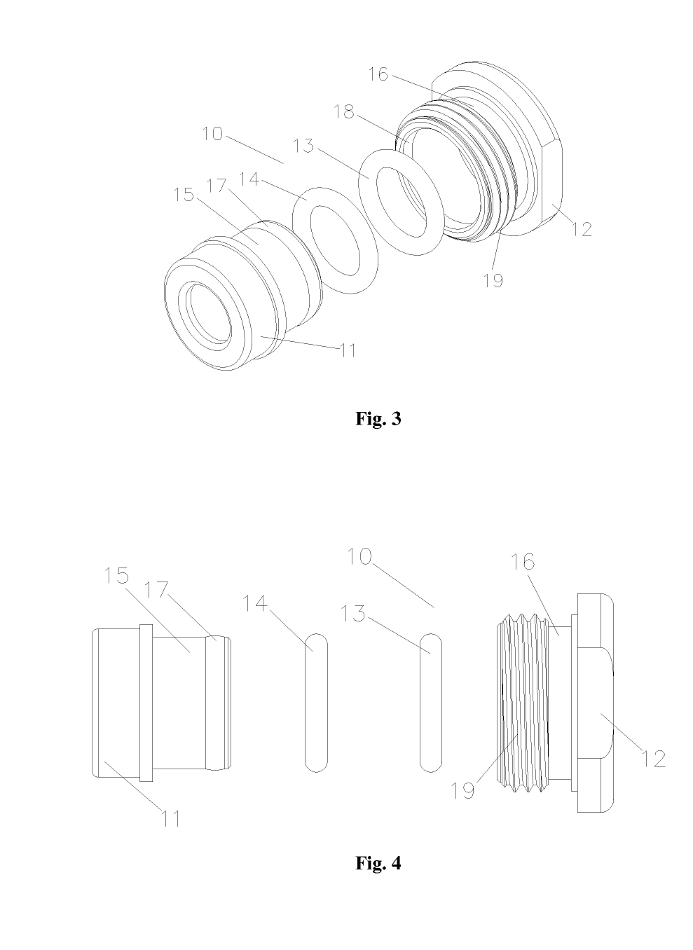

The first sealing ring 13 and the second sealing ring 14 can be sealing rings with any shape, and can be regular sealing rings or irregular sealing rings. Preferably, the first sealing ring 13 and the second sealing ring 14 are any one of an O-ring, a rectangular ring and a square ring respectively. Please refer to FIG. 3 and FIG. 4, in one embodiment of the present invention, the first sealing ring 13 and the second sealing ring 14 both are O-rings.

The material of the first sealing ring 13 and the second sealing ring 14 can be any suitable material, for example, silicone rubber, EPDM, nitrile rubber, and all materials that can be used for sealing, the material preferably has a suitable compression ratio, for example, generally a 20% to 30% compression rate. For an O-ring, the calculation formula of the compression ratio is:

W=(dₒ−h)/dₒ×100%

Wherein, dₒ: the diameter (mm) of the cross section of the O-ring under the free state, h: the distance of the bottom of the O-ring's groove, i.e. the height (mm) of the cross section of the O-ring compressed.

The first end 15 can not be restricted by the clamping nut 12 in a direction away from the clamping nut 12. Preferably, the first end 15 is restricted by the clamping nut 12 in a direction away from the clamping nut 12. Therefore the cable clamping component 11 would not be separated from the clamping nut 12, and form one component, i.e. a one-piece structure, with the clamping nut 12.

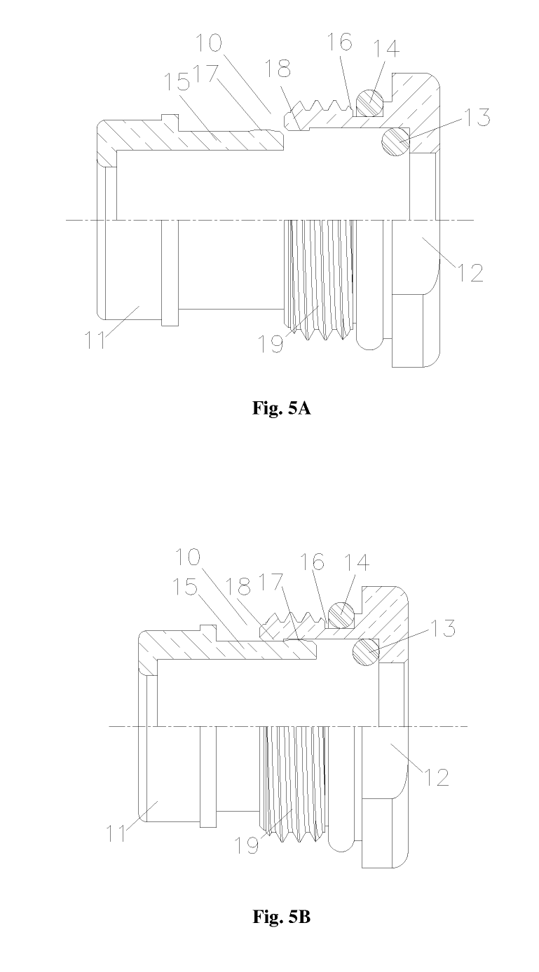

The first end 15 and the clamping nut 12 can be connected in any suitable manner. Preferably, the first end 15 and the clamping nut 12 are connected in press-fit connection. Please refer to FIG. 2, FIG. 5A and FIG. 5B, in one embodiment of the present invention, a first convex part 17 is arranged on the surface of the outer side of the first end 15, a second convex part 18 is arranged on the surface of the inner side of the clamping nut 12, the first convex part 17 is positioned between the second convex part 18 and the first sealing ring 13 and restricted by the second convex part 18 in a direction away from the clamping nut 12, so that the first end 15 and the clamping nut 12 are connected in press-fit connection. In this way, the first end 15 of the cable clamping component 11 is snapped into the clamping nut 12, the cable clamping component 11 can rotate longitudinally and is restricted axially in the clamping nut 12, so as to form one component, i.e. an one-piece structure, with the clamping nut 12, for one customer, the cable installation assembly i.e. the present invention he obtains has only one component, not only it shortens the cable installation time, but also the customer does not worry about missing parts, the installation is easy, and the parts are not easy to miss; secondly, the clamping nut 12 can rotate freely and independently relative to the cable clamping component 11, and the cable clamping component 11 is used to position the cable and prevent the cable from rotating following the rotation of the clamping nut 12.

The first end 15 and the clamping nut 12 also can be connected in thread connection. For example, a first thread (not shown) is arranged on the surface of the outer side of the first end 15, a second thread (not shown) is arranged on the surface of the inner side of the clamping nut 12, the first thread is engaged with the second thread, so that the first end 15 and the clamping nut 12 are connected in thread connection. It also can be achieved that the cable clamping component 11 and the clamping nut 12 form one component, i.e. a one-piece structure

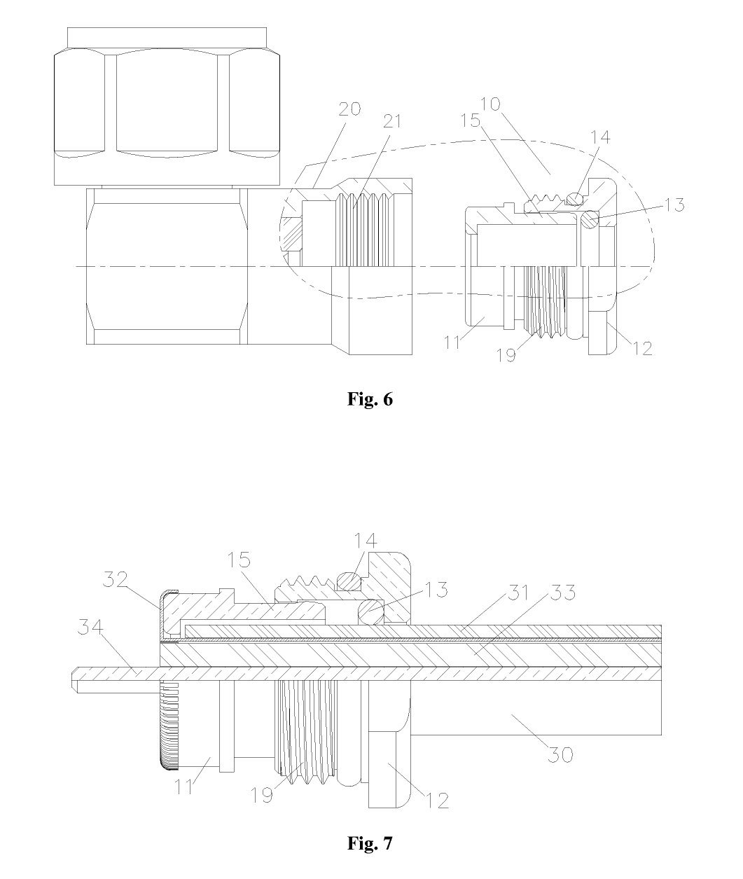

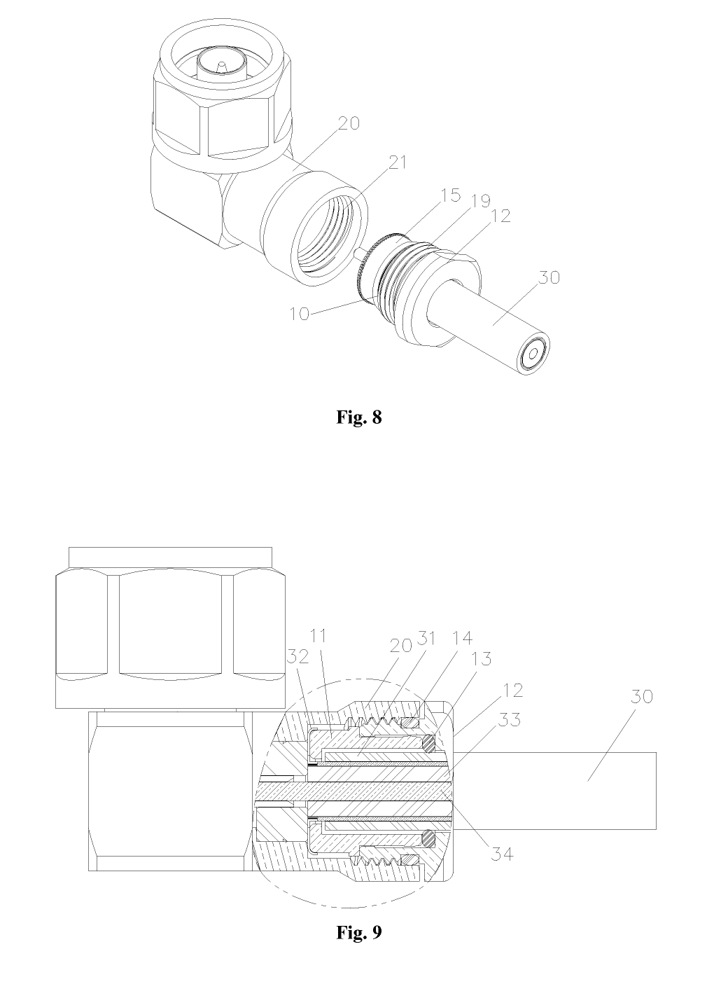

Any suitable manner can be adopted to connect the clamping nut 12 and the connector main body 20. Preferably, the clamping nut 12 is used to be connected with the connector main body 20 in thread connection. Please refer to FIG. 2, FIG. 5A and FIG. 5B, in one embodiment of the present invention, a third thread 19 used to be connected with the connector main body 20 in thread connection is arranged on the surface of the outer side of the clamping nut 12. Please refer to FIG. 6, FIG. 8 and FIG. 9, correspondingly, a fourth thread 21 is arranged on the inner surface of the connector main body 20, and used to be engaged with the third thread 19 on the surface of the outer side of the clamping nut 12.

The clamping nut 12 can also be connected with the connecter main body 20 in press-fit connection. For example, a third convex part (not shown) used to be connected with the connector main body 20 in press-fit connection is arranged on the surface of the outer side of the clamping nut 12. Correspondingly, a fourth convex part (not shown) is arranged on the inner surface of the connector main body 20, once the third convex part on the surface of the outer side of the clamping nut 12 is snapped into the connector main body 20, the fourth convex part on the inner surface of the connector main body 20 will restrict the third convex part on the surface of the outer side of the clamping nut 12, so as to prevent the clamping nut 12 from being separated from the connector main body 20.

Please refer to FIG. 3-5B, when the dual sealing structure 10 of RF coaxial connector of the present invention is assembled, the first sealing ring 13 and the second sealing ring 14 are positioned inside the surface of the inner side and on the surface of the outer side of the clamping nut 12 respectively, then the first end 15 of the cable clamping component 11 is pressed into the clamping nut 12, the first convex part 17 and the second convex part 18 are deformed to a certain degree when the first convex part 17t contacts the second convex part 18 during the pressing period, then the first convex part 17 passes through the second convex part 18 and is squeezed into the clamping nut 12, then they return to their original states, so as to achieve restricting the first convex part 17 by the second convex part 18.

Please refer to FIG. 6, when the dual sealing structure 10 and the connecter main body 20 of RF coaxial connector of the present invention are connected, the cable clamping component 11 is inserted ahead into the connecter main body 20, then the clamping nut 12 is rotated, to fix the dual sealing structure 10 of RF coaxial connector of the present invention in the connecter main body 20 through the thread engagement of the third thread 19 of the clamping nut 12 and the fourth thread 21 of the connecter main body 20.

Please refer to FIG. 7-9, in the specific application, the outer shielding layer 31 of one end of a RF coaxial cable 30 is removed, to expose the outer conductor 32, the RF coaxial cable 30 is sheathed by the present invention, wherein the outer conductor is sheathed by the cable clamping component 11 which props against the cross-section of the outer shielding layer 31, then the outer conductor 32 is folded upwards and the inner shielding layer 33 exposed is removed, so as to expose the center conductor 34, then this assembly above is inserted into the connector main body 20, the clamping nut 5 is rotated to be connected with the connector main body 20 through a thread engagement.

Please refer to FIG. 9, when the dual sealing structure 10 and the connecter main body 20 of RF coaxial connector of the present invention are connected, the first sealing ring 13 is positioned between the cable clamping component 11 and the clamping nut 12 and props against the cable clamping component 11 and the clamping nut 12 respectively, to form a first sealing, for sealing the clamping nut 12 and the RF coaxial cable 30; the second sealing ring 14 is positioned between the connector main body 20 and the clamping nut 12 and props against the connector main body 20 and the clamping nut 12 respectively, to form a second sealing, for sealing the clamping nut 12 and the connector main body 20, due to the dual sealing, the sealing effect is remarkable. For the dual sealing rings won't be destroyed in the installation, they can be installed many times.

To sum up, the dual sealing structure of RF coaxial connector of the present invention is designed skillfully, has not only a good sealing effect, but also fewer components, is simple to manufacture and of low production cost, its components can not be easily lost, its installation time is short, it can be installed repeatedly, and its use cost is low, therefore the present invention is suitable for large-scale popularization.

In the present specification, the present invention has been described according to the particular embodiments. But it is obvious that these embodiments can be modified or changed without departure from the spirit and scope of the present invention. Therefore, the specification and drawings described above are exemplary only and not intended to be limiting.

We claim:

1. A dual sealing structure of RF coaxial connector, comprising:
a clamping nut, used to be connected with the connector main body of the RF coaxial connector;
a cable clamping component, comprising a first end which is arranged movably in the clamping nut;
a first sealing ring, positioned inside the surface of the inner side of the clamping nut and located between the end face of the first end and the inner wall of the clamping nut; and
a second sealing ring arranged on the surface of the outer side of the clamping nut and used to be sealed with the connector main body.

2. The dual sealing structure of RF coaxial connector according to claim 1, wherein the first end is restricted by the clamping nut in a direction away from the clamping nut.

3. (canceled)

4. The dual sealing structure of RF coaxial connector according to claim 3, wherein a first convex part is arranged on the surface of the outer side of the first end, a second convex part is arranged on the surface of the inner side of the clamping nut, the first convex part is positioned between the second convex part and the first sealing ring and restricted by the second convex part in a direction away from the clamping nut, so that the first end and the clamping nut are connected in press-fit connection.

5. The dual sealing structure of RF coaxial connector according to claim 3, wherein a first thread is arranged on the surface of the outer side of the first end, a second thread is arranged on the surface of the inner side of the clamping nut, the first thread is engaged with the second thread, so that the first end and the clamping nut are connected in thread connection.

6. (canceled)

7. The dual sealing structure of RF coaxial connector according to claim 6, wherein a third convex part used to be connected with the connector main body in press-fit connection is arranged on the surface of the outer side of the clamping nut.

8. The dual sealing structure of RF coaxial connector according to claim 6, wherein a third thread used to be connected with the connector main body in thread connection is arranged on the surface of the outer side of the clamping nut.

9. The dual sealing structure of RF coaxial connector according to claim 1, wherein the first sealing ring and the second sealing ring are any one of an O-ring, a rectangular ring and a square ring respectively.

10. A dual sealing structure of RF coaxial connector, comprising:
a clamping nut, used to be connected with the connector main body of the RF coaxial connector in press-fit or thread connection;
a cable clamping component, comprising a first end which is arranged movably in the clamping nut and restricted by the clamping nut in a direction away from the clamping nut;
a first sealing ring, positioned inside the surface of the inner side of the clamping nut and located between the end face of the first end and the inner wall of the clamping nut; and
a second sealing ring arranged on the surface of the outer side of the clamping nut and used to be sealed with the connector main body.

11. (canceled)

12. The dual sealing structure of RF coaxial connector according to claim 11, wherein a first convex part is arranged on the surface of the outer side of the first end, a second convex part is arranged on the surface of the inner side of the clamping nut, the first convex part is positioned between the second convex part and the first sealing ring and restricted by the second convex part in a direction away from the clamping nut, so that the first end and the clamping nut are connected in press-fit connection.

13. The dual sealing structure of RF coaxial connector according to claim 11, wherein a first thread is arranged on the surface of the outer side of the first end, a second thread is arranged on the surface of the inner side of the clamping nut, the first thread is engaged with the second thread, so that the first end and the clamping nut are connected in thread connection.

14. The dual sealing structure of RF coaxial connector according to claim 10, wherein a third convex part used to be connected with the connector main body in press-fit connection is arranged on the surface of the outer side of the clamping nut.

15. The dual sealing structure of RF coaxial connector according to claim 10, wherein a third thread used to be connected with the connector main body in thread connection is arranged on the surface of the outer side of the clamping nut.

16. The dual sealing structure of RF coaxial connector according to claim 10, wherein a third thread used to be connected with the connector main body in thread connection is arranged on the surface of the outer side of the clamping nut.

17. A RF coaxial connector, comprising:
a connector main body;
a clamping nut, connected with the connector main body;
a cable clamping component, positioned in the connector main body and comprising a first end which is arranged movably in the clamping nut;
a first sealing ring, positioned inside the surface of the inner side of the clamping nut and located between the end face of the first end and the inner wall of the clamping nut; and
a second sealing ring arranged on the surface of the outer side of the clamping nut and sealed with the connector main body.

18. The RF coaxial connector according to claim 17, wherein the first end is restricted by the clamping nut in a direction away from the clamping nut.

19. The RF coaxial connector according to claim 17, wherein the first end and the clamping nut are connected in press-fit or thread connection.

20. The RF coaxial connector according to claim 19, wherein a first convex part is arranged on the surface of the outer side of the first end, a second convex part is arranged on the surface of the inner side of the clamping nut, the first convex part is positioned between the second convex part and the first sealing ring and restricted by the second convex part in a direction away from the clamping nut, so that the first end and the clamping nut are connected in press-fit connection.

21. The RF coaxial connector according to claim 19, wherein a first thread is arranged on the surface of the outer side of the first end, a second thread is arranged on the surface of the inner side of the clamping nut, the first thread is engaged with the second thread, so that the first end and the clamping nut are connected in thread connection.

22. (canceled)

23. The RF coaxial connector according to claim 22, wherein a third convex part is arranged on the surface of the outer side of the clamping nut, a fourth convex part is arranged on the inner surface of the connector main body, the third convex part is positioned between the fourth convex part and the interior of the connector main body and restricted by the fourth convex part in a direction away from the connector main body, so that the clamping nut and the connector main body are connected in press-fit connection.

24. The RF coaxial connector according to claim 22, wherein a third thread is arranged on the surface of the outer side of the clamping nut, a fourth thread is arranged on the inner surface of the connector main body, the third thread is engaged with the fourth thread, so that the clamping nut and the connector main body are connected in thread connection.
